(19) United States
(12) Patent Application Publication
(10) Pub. No.: US 2007/0036054 A1
(43) Pub. Date: Feb. 15, 2007

(54) Optical disk apparatus

(75) Inventor: Shinichi Tatsuta, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Kabushiki Kaisha Toshiba

(21) Appl. No.: 11/385,322

(22) Filed: Mar. 15, 2006

(30) Foreign Application Priority Data
Aug. 11, 2005 (JP) 2005-233447

(51) Int. Cl. G11B 15/04

(52) U.S. Cl. 369/53.24

(57) ABSTRACT

An optical disk apparatus which reproduces information stored along tracks in recording layers of an optical disk includes a light illuminating medium which illuminates a light beam to a target track and at least one specific track of the optical disk, a reproduction unit which detects a reflected light beam from the optical disk to generate a first reproduction signal from the target track and a second reproduction signal from the specific track, a memory which stores a compensation signal obtained on the basis of the second reproduction signal and corresponding to a cross talk component between the recording layers, a subtracter which subtracts the compensation signal from the first reproduction signal to generate a third reproduction signal, and a decoder which decodes the third reproduction signal to obtain the information.

### CROSS-REFERENCE TO RELATED APPLICATIONS

This application is based upon and claims the benefit of priority from prior Japanese Patent Application No. 2005-233447, filed Aug. 11, 2005, the entire contents of which are incorporated herein by reference.

### BACKGROUND OF THE INVENTION

1. Field of the Invention

The present invention relates to an optical disk apparatus which reproduces information recorded in a multilayer optical disk.

2. Description of the Related Art

There has widely spread an optical disk apparatus which records and reproduces information by using a recording medium called an optical disk which is typified by a compact digital (CD) disk or a digital versatile digital (DVD) disk. With spread of the optical disk apparatus, an increase in applications and advancement of peripheral technologies, a recording capacity of an optical disk is increasing. A recording capacity of a CD is approximately 700 MB, whereas a recording capacity of a DVD is 4.7 GB. Further, it is predicted that a recording capacity of a next-generation DVD which is currently under development will exceed 20 GB.

An increase in recording capacity of an optical disk is mainly achieved by an increase in a recording density per unit area. An increase in recording density is mainly realized by attainment of a short wavelength of a semiconductor laser and a high numerical aperture (NA) of an object lens. Assuming that λ is a wavelength of a laser beam, an increase in recording capacity is realized based on a principle that a spot size is proportional to λ/NA. For example, in a DVD, a semiconductor laser having λ=660 nm and an object lens having NA=0.6 are used. On the other hand, in a next-generation DVD, it is predicted that a semiconductor laser having λ=405 nm and an object lens having NA=0.65 or 0.85 will be used, and a spot size will be reduced to approximately ½.

A recording density can be increased by simply further advancing realization of a shorter wavelength and a higher NA. In reality, however, it is generally considered that an improvement in recording density based on realization of a shorter wavelength and a higher NA is difficult. This is based on various reasons. For example, development of optical materials/optical components suitable for a shorter wavelength is difficult, and a margin with respect to a tilt of a disk becomes suddenly severe.

As a technique of improving a recording density other than realization of a shorter wavelength and a higher NA, a multilayer recording technology has been known. This is a technology which realizes a recording density which is several-fold of an optical disk having a single layer in terms of layers by using an optical disk in which recording layers are overlapped. For example, a two-layer medium has been put to practical use in the DVD. At the time of recording/reproducing information in a multilayer optical disk, a target recording layer must be selected. Therefore, there is adopted a method by which a gap between recording layers is largely set to approximately several-ten μm and then a focal point of a laser beam is moved in a thickness direction. However, at the time of reproduction, although reflected light alone from a recording layer as a reproduction target (which will be referred to as a reproduction layer hereinafter) must be led to a photodetector to generate a reproduction signal, reflected light from a recording layer other than the reproduction layer (which will be referred to as a non-reproduction layer hereinafter) also leaks to the photodetector. Such a phenomenon is called interlayer cross talk. If there is the interlayer cross talk, a noise component in a reproduction signal is increased.

As a factor of the interlayer cross talk, there is relative eccentricity between recording layers (a shift of a central axis of each recording layer). This eccentricity brings a shift to a land-groove structure between a reproduction layer and a non-reproduction layer. That is, light also cuts across the land-groove of the non-reproduction layer during reproduction from the reproduction layer, and a light quantity of leak light from the non-reproduction layer fluctuates at this time. Therefore, the leak light increases a noise component. If the eccentricity can be reduced to zero, an interlayer cross talk component can be removed in principle. However, generation of eccentricity which is approximately several microns to several-ten micros is unavoidable in current manufacturing steps.

Jpn. Pat. Appln. KOKAI No. 2001-273640 discloses a technique which reduces an influence of interlayer cross talk by providing a sub-photodetector which detects reflected light alone from a non-reproduction layer separately from a main photodetector which detects reflected light from a reproduction layer. That is, an output signal from the main photodetector is processed by using an output signal from the sub-photodetector, thereby reducing an interlayer cross talk component included in a reproduction signal from the reproduction layer.

In the technique disclosed in Jpn. Pat. Appln. KOKAI No. 2001-273640, the sub-photodetector is newly required, and an optical component which leads reflected light from an optical disk to the sub-photodetector must be thereby added as compared with a regular optical disk apparatus. Therefore, a size of an optical disk apparatus including an optical system is increased, and a cost also becomes high.

### BRIEF SUMMARY OF THE INVENTION

According to one aspect of the present invention, there is provided an optical disk apparatus, which reproduces information stored along tracks on an optical disk having recording layers, includes a light illuminating medium which illuminates a light beam to a target track and at least one specific track of the optical disk, a reproduction unit which generates a first reproduction signal from the target track and a second reproduction signal from the specific track by detecting a reflected light beam from the optical disk, a memory which stores a compensation signal obtained on the basis of the second reproduction signal and corresponding to a cross talk component between the recording layers, a subtracter which subtracts the compensation signal from the first reproduction signal to generate a third reproduction signal, and a decoder which decodes the third reproduction signal to obtain the information.

### BRIEF DESCRIPTION OF THE SEVERAL VIEWS OF THE DRAWING

FIG. 1 is a view showing an optical disk apparatus according to a first embodiment of the present invention;

FIG. 2 is a view showing a state of relative eccentricity between a zeroth recording layer and a first recording layer in a two-layer optical disk;

FIG. 3 is a flowchart showing a processing procedure of reducing an interlayer cross talk component in the first embodiment;

FIG. 4 is a block diagram showing a reproduction signal processing section in an optical disk apparatus according to a second embodiment of the present invention;

FIG. 5 is a flowchart showing a processing procedure of reducing an interlayer cross talk component in the second embodiment;

FIGS. 6A, 6B and 6C are waveform charts illustrating an interlayer cross talk reduction effect by the second embodiment;

FIG. 7 is a block diagram of a reproduction signal processing section in an optical disk apparatus according to a third embodiment of the present invention; and

FIG. 8 is a flowchart showing a processing procedure of reducing an interlayer cross talk component in the third embodiment.

### DETAILED DESCRIPTION OF THE INVENTION

Embodiments according to the present invention will now be described hereinafter in detail with reference to the accompanying drawings. In the following embodiments, the most general land-groove structure in a rewritable optical disk as a multilayer optical disk is assumed.

(First Embodiment)

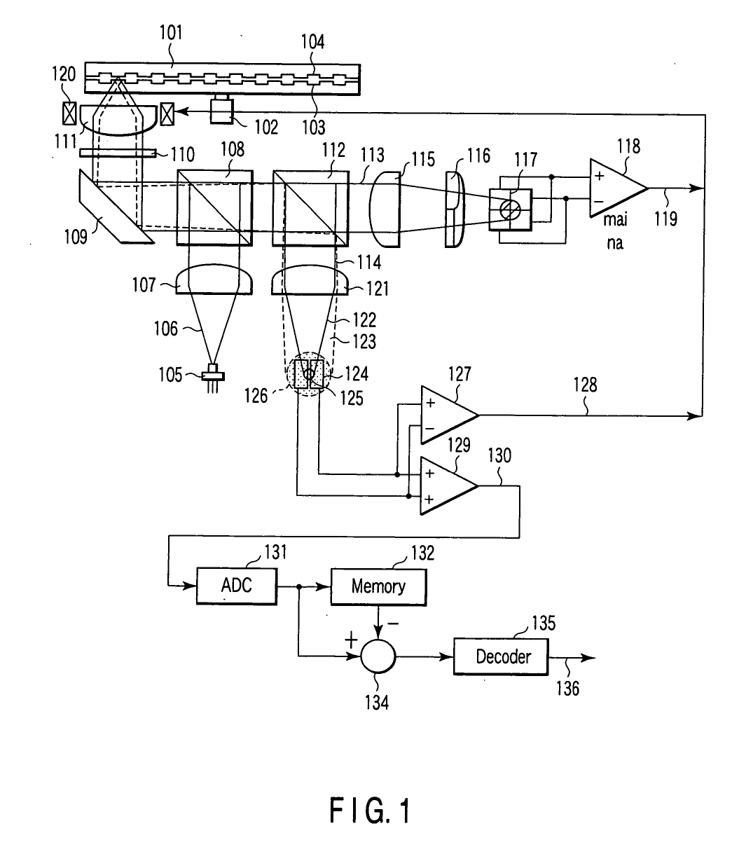

FIG. 1 shows an optical head apparatus according to a first embodiment of the present invention. An optical disk 101 is a two-layer optical disk having two recording layers 103 and 104 in which a spiral groove region and a land region are formed as tracks. In the land-groove structure of the rewritable optical disk, information is recorded in both the groove region and the land region. The recording layer 103 close to an incidence side of a light beam is called a zeroth recording layer, and the recording layer apart from the incidence side of the light beam is called a first recording layer. The optical disk 101 is driven to rotate by a spindle motor 102 at the time of recording and reproduction.

When recording information in the zeroth recording layer 103 or the first recording layer 104, or when reproducing information from the zeroth recording layer 103 or the first recording layer 104, a light beam is illuminated and converged on a recording layer as a recording target or a recording layer (a reproduction layer) as a reproduction target by a light illuminating medium including a laser beam source 105, a collimator lens 107, a polarizing beam splitter 108, a rising mirror 109, a ¼ wave plate 110, and an object lens 111.

Giving a description on a reproducing operation, a linearly polarized light beam 106 emitted from the laser beam source 105 is converted into a parallel light beam from a diverging light beam by the collimator lens 107, then sequentially reflected by the polarizing beam splitter 108 and the rising mirror 109, and then enters the ¼ wave plate 110. The parallel light beam which has entered the ¼ wave plate 110 is converted into a circular polarized light, and converged on the reproduction layer in the two-layer optical disk 101 by the object lens 111.

The light reflected by the reproduction layer is transmitted through the object lens 111 and the ¼ wave plate 110, converted into a linear polarized light by the ¼ wave plate 110, reflected by the rising mirror 109, and transmitted through the polarizing beam splitter 108 in a reverse order of the incident light. The light transmitted through the polarizing beam splitter 108 is divided into a focusing control light beam 113 and a tracking control and reproduction light beam 114 by the beam splitter 112.

The focusing control light beam 113 transmitted through the beam splitter 112 is condensed on a first photodetector 117 by a condenser lens 115 and a cylindrical lens 116. The first photodetector 117 is at least a four-segments detector having four light receiving faces, each of which generates an output signal depending on incident light quantity. Output signals respectively corresponding to the light receiving faces of the photodetector 117 are input to a focusing error calculator 118 where a calculation is carried out based on a known astigmatic method to generate a focusing error signal 119.

The object lens 111 is driven in a direction perpendicular to faces of the recording layers 103 and 104 by a lens actuator 120 based on the focusing error detection signal. As a result, a light beam is focused on the reproduction layer. Although the typical astigmatic method has been described here as a focusing error detection method, the focusing error detection method is not limited to this method, and methods such as a knife edge method or a beam size method may be used.

The tracking control and reproduction light beam 114 reflected by the beam splitter 112 is condensed by a condenser lens 121, and received by a second photodetector 124. The second photodetector 124 is at least a two-segments detector having two light receiving faces, each of which generates an output signal depending on incident light quantity. Output signals respectively corresponding to the light receiving faces of the second photodetector 124 are input to a tracking error calculator 127 where a calculation is carried out based on a known calculation method to generate a tracking error signal 128.

When the second photodetector 124 is the two-segments detector, the tracking error calculator 127 is a subtracter (or a differential amplifier). The tracking error signal 128 generated by the subtracter is called a push-pull signal. The object lens 111 is driven along in-plane directions of the recording layers 103 and 104 by the lens actuator 120 in accordance with a tracking drive signal generated based on the tracking error signal 128, and the light beam is positioned on a target track on the reproduction layer.

The output signal corresponding to each light receiving face of the second photodetector 124 is also input a reproduction calculator 129, which constitutes a reproduction unit in cooperation with the second photodetector 124. When the second photodetector 124 is a segment detector, the reproduction calculator 129 is an adder (or an addition amplifier). The reproduction calculator 129 adds the output signal corresponding to each light receiving face of the second photodetector to generate a reproduction signal 130 corresponding to information recorded on the reproduction layer of the optical disk 101.

Of light beams which enter the photodetector 124, a light beam indicated by a solid line 122 is a light beam (a signal light beam) reflected by the reproduction layer (the first recording layer 104 in FIG. 1) in the two-layer optical disk 101. A light beam indicated by a broken line 123 represents a light beam reflected by a non-reproduction layer (the zeroth recording layer 103 in FIG. 1) of the two-layer optical disk 101. The light beams 122 and 123 respectively correspond to beams 125 and 126 in the second photodetector 124.

A light beam 123 which is unwanted leak light from the non-reproduction layer as well as the signal light beam 122 from the reproduction layer enters the second photodetector 124, and this leak light beam 123 is superposed on the signal light beam 122. As a result, an interlayer cross talk component is mixed in a reproduction signal 130 from the reproduction calculator 129. In this embodiment, the interlayer cross talk component in the reproduction signal 130 is reduced in the following manner. It is to be noted that a shape of the track on the optical disk 101 is formed into one continuous spiral shape, but the track corresponding to one track circuit is determined as one track for the convenience's sake in the following explanation.

The reproduction signal 130 is converted into digital data by an analog-digital converter (ADC) 131. According to the first embodiment, the digital data from the ADC 131 is input to a memory 132 and a subtracter 134. The memory 132 stores digital data (a second reproduction signal data) of a reproduction signal from one specific track other than a target track. Here, the target track is a track in a region of the optical disk 101 where information (a recording mark) is recorded, and is a track from which information is reproduced. The specific track is, e.g., a track in a region of the optical disk 101 where the information is not recorded. Although the specific track is preferably a track on the same recording layer as the recording layer of the target track, it may be a track on a recording layer different from the recording layer of the target track.

The second reproduction signal data (a compensation signal data) from the specific track recorded in the memory 132 is read when reproducing the information from the target track, and it is subtracted from digital data (first reproduction signal data) of the reproduction signal from the target track by the subtracter 134, thereby obtaining digital data (which will be referred to as third reproduction signal data) of the reproduction signal from which an interlayer cross talk component is reduced. The third reproduction signal data output from the subtracter 134 is decoded by a decoder 135, thereby generating reproduced information 136.

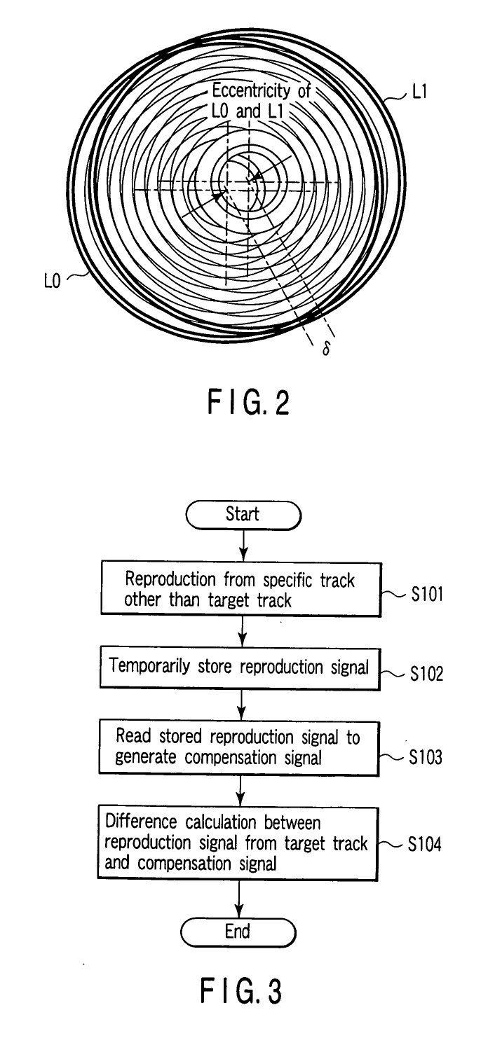

FIG. 2 shows a state of relative eccentricity between the zeroth recording layer 103 and the first recording layer 104 of the optical disk 101. A shape of the track, i.e., the land-groove structure is generally a spiral shape, but the land-groove structure is schematically represented as a concentric shape for simplicity in FIG. 2. As indicated by a symbol δ in FIG. 2, when the zeroth recording layer 103 (L0 in FIG. 2) and the first recording layer 102 (L1 in FIG. 2) are eccentric with respect to each other, the land-groove structure of the recording layer L0 and that of L1 are overlapped in a shifted state. As apparent from FIG. 2, an angle at which a track of the recording layer L0 and a track of the recording layer L1 cut across each other is always the same at any radial position on the optical disk, and hence an interlayer cross talk component is generated in reproduction signals from the recording layer L0 and the recording layer L1 in the same phase with respect to a rotation angle.

Therefore, when a recording mode of the optical disk 101 is a constant linear velocity (CLV) mode or a zone constant linear velocity (ZCLV) mode, sampling the reproduction signal from the recording layer L0 and the reproduction signal from the recording layer L1 in a sampling cycle corresponding to the same rotation angle by the ADC 131 allows the interlayer cross talk components from each of recording layers L0 and L1 included in digital data output from the ADC 131 to have the same phase.

When the ADC 13 does not sample the reproduction signal from the recording layer L0 and the reproduction signal from the recording layer L1 in the sampling cycle corresponding to the same rotation angle, the digital data from the ADC 131 is subjected to an interpolating calculation to perform conversion so that the number of sampling points for each track is the same, for example. Such conversion based on the interpolating calculation can uniform phases of the interlayer cross talk components from recording layer L0 and the recording layer L1 included in the digital data from the ADC 131. When the recording mode of the optical disk 101 is a constant angular velocity (CAV), the number of sampling points for each track is the same even if the sampling cycle of the ADC 131 is unchanged, and hence the interpolating calculation is not necessary.

Generation of a compensation signal does not have to be necessarily performed every time reproduction from a target track is carried out. For example, when a fluctuation in an interlayer cross talk component due to a difference in radial position on the optical disk 101 is small, generation of a compensation signal may be carried out each time for each medium (an optical disk), the obtained compensation signal may be stored in a compensation signal memory, and the compensation signal stored in the compensation signal memory may be read at the time of reproduction. When a fluctuation in an interlayer cross talk component due to a difference in radial position on the optical disk 101 is large, it is desirable to generate compensation signals at positions (several positions to several-ten positions) having different radial positions and apply an appropriate compensation signal corresponding to a radial position. These operations are likewise applied to later-described second and third embodiments.

A processing procedure of reducing an interlayer cross talk component in the first embodiment will now be described with reference to FIG. 3.

First, reproduction from a specific track other than a target track of the optical disk 101 is performed (a step S101). A reproduction signal obtained from the specific track at the step S101 is converted into digital data by the ADC 131, and second reproduction signal data obtained by this conversion is written and temporarily stored in the memory 132 (a step S02). As described above, the target track is a track in a region of the optical disk 101 where information is recorded, and the specific track is a track in a region of the optical disk 101 where the information is not recorded.

Then, the second reproduction signal data stored from the specific track stored in the memory 132 is read, and the read data is generated as compensation signal data (a step S103). Since the reproduction signal from the specific track contains components other than the information recorded in the target track, i.e., an interlayer cross talk component and other noise components alone, the reproduction signal can be used as a compensation signal which reduces the interlayer cross talk component.

Thus, at the time of reproduction of the target track, the second reproduction signal data from the specific track is read from the memory 132, and the read data is input as compensation signal data to the subtracter 134. The subtracter 134 subtracts the compensation signal data from the first reproduction signal data from the target track output from the ADC 131, i.e., performs a difference calculation (a step S104). This difference calculation provides third reproduction signal data in which the interlayer cross talk component has been reduced. Therefore, when the third reproduction signal data output from the subtracter 134 is decoded by the decoder 135, reproduction information 136 which is not affected by the interlayer cross talk is obtained.

Incidentally, when the recording layer of the specific track is different from the recording layer of the target track, it is desirable to perform any processing such as adjustment of a phase or amplitude considering a difference in recording layer with respect to the compensation signal data and then carry out the difference calculation.

(Second Embodiment)

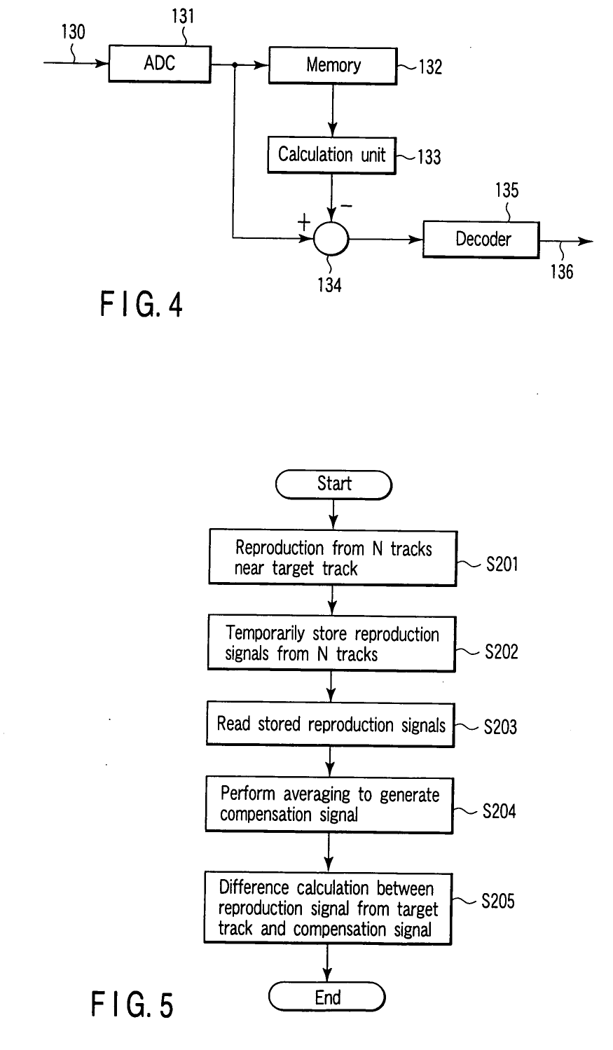

A second embodiment according to the present invention is different from the first embodiment in processing of reducing an interlayer cross talk component. According to the second embodiment, as shown in FIG. 4, reproduction signal data read from a memory 132 is input to a calculation unit 133. In this embodiment, the memory 132 has a capacity capable of storing reproduction signal data from N tracks. The calculation unit 133 performs calculation processing with respect to reproduction signal data corresponding to N tracks from the memory 132 to generate compensation signal data which is used to reduce an interlayer cross talk component. At the time of reproduction from a target track, the subtracter 134 performs a difference calculation between reproduction signal data from a target track and compensation signal data, thereby obtaining reproduction signal data in which an interlayer cross talk component is eliminated or reduced.

A description will now be given as to a processing procedure of reducing an interlayer cross talk component in the second embodiment with reference to FIG. 5.

First, reproduction is sequentially carried out from N tracks in the vicinity of a target track of an optical disk 101 (a step S201). Reproduction signals obtained from the N tracks at the step S201 are converted into digital data by an ADC 131, and then written and temporarily stored in the memory 132 (a step S202). Subsequently, at the time of reproduction from the target track, the reproduction signal data from the N tracks stored in the memory 132 is read (a step S203), and such averaging as represented by the following Equation (1) is performed by a calculation unit 133, thereby generating compensation signal data (a step S204).

$$Weq ( t ) = \frac{{\sum }_{i = 1}^{N} Wi ( t )}{N} \qquad ( 1 )$$

where Wi(t) is reproduction signal data from an ith track in the N tracks.

When the reproduction signal data from the N tracks in the vicinity of the target track is averaged in this manner, a random noise component or recording data component is reduced, and a compensation signal mainly consisting of an interlayer cross talk component is generated. Therefore, like the first embodiment, when a subtracter 134 performs a difference calculation between the reproduction signal data from the target track output from the ADC 131 and the compensation signal data, it is possible to obtain the reproduction signal data in which the interlayer cross talk component is effectively removed or reduced.

An effect of reducing the interlayer cross talk according to the second embodiment will now be described while taking specific waveforms as an example.

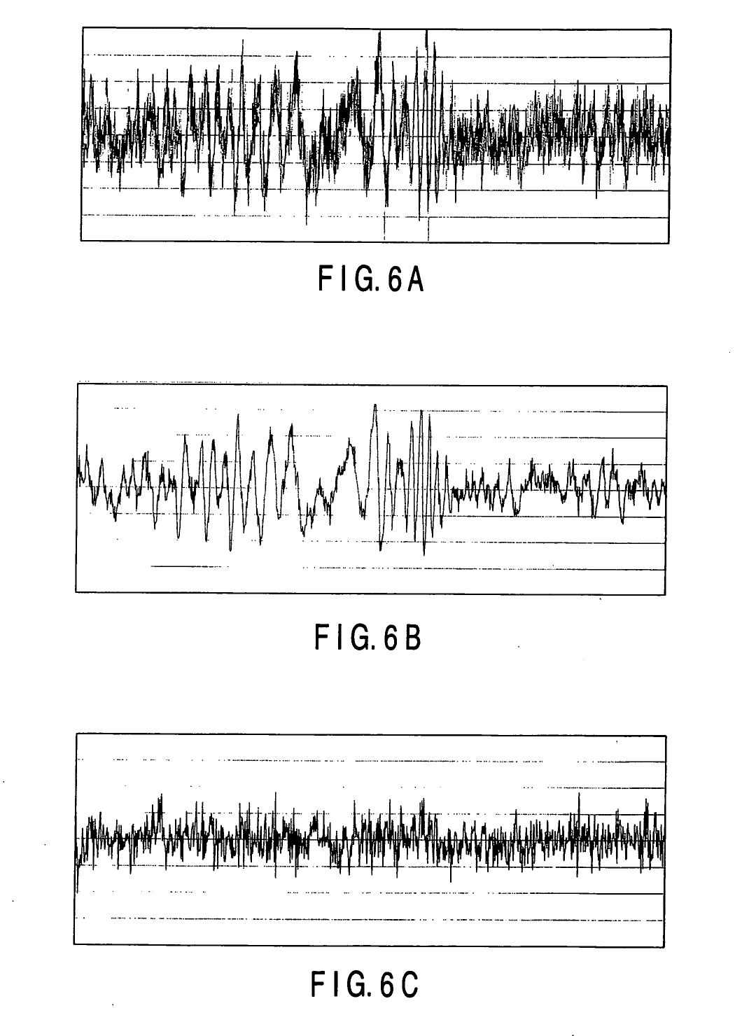

FIG. 6A shows waveforms in a partial section of reproduction signals from N=5 tracks in the vicinity of the target track in an superimposing manner. The waveforms shown in FIG. 6A contain the interlayer cross talk component and a random noise component other than this. FIG. 6B shows a waveform of a compensation signal obtained by averaging the reproduction signal waveforms from the N tracks depicted in FIG. 6A. In this compensation signal waveform, the random noise component contained in FIG. 6A is substantially canceled by averaging, and a large part is the interlayer cross talk component. FIG. 6C shows a waveform of a reproduction signal obtained as a result of performing a difference calculation between the reproduction signal from the target track and the compensation signal depicted in FIG. 6B, the interlayer cross talk component is substantially cancelled, and the random noise component alone remains. Since a track in which a recording mark is not formed is determined as a target track for the convenience's sake in the example of FIG. 6C, an information component is not included. As described above, according to the second embodiment, the interlayer cross talk component can be effectively reduced.

In the second embodiment, likewise, when the ADC 13 does not sample a reproduction signal from a recording layer L0 and a reproduction signal from a recording layer L1 in a sampling cycle corresponding to the same rotational angle, it is desirable to perform an interpolating calculation with respect to digital data from the ADC 131 and carry out conversion in such a manner the number of sampling points becomes the same for each track circuit. As a result, it is possible to uniform phases of the interlayer cross talk components from the recording layer L0 and the recording layer L1 contained in the reproduction signal data.

Generation of a compensation signal in the second embodiment does not have to be necessarily carried out by using reproduction signals alone from neighboring tracks other than the target track prior to reproduction from the target track. It is possible to utilize the reproduction signals from the neighboring tracks including the target track to generate the compensation signal simultaneously with reproduction from the target track.

In the second embodiment, the compensation signal data is generated by averaging according to Equation (1) every time the reproduction signal is obtained, but may be generated prior to the obtainment of the reproduction signal. In this case, the generated compensation signal data may be stored in, for example, the memory 132, and read from the memory 132 and input into the subtracter 134 when the reproduction signal is obtained. Alternatively, the calculation unit 133 may include a memory, in which the generated compensation signal data is stored instead of the memory 132. These manners also belong in the scope of the present invention.

(Third Embodiment)

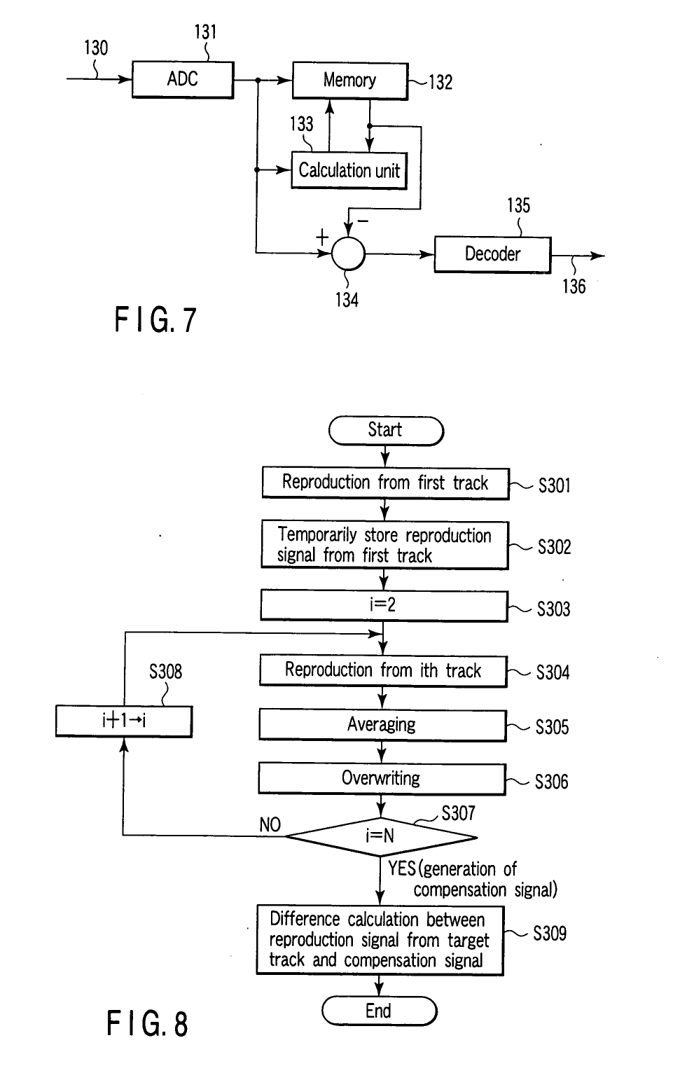

FIG. 7 shows a third embodiment according to the present invention which is a modification of FIG. 4. Reproduction signal data from an ADC 131 is also input to a calculation unit 133. There are a path extending from an output of a memory 132 to an input of the calculation unit 133, a path extending from an output of the calculation unit 133 to an input of the memory 132, and a path from an output of the memory 132 to a subtracter 134. The memory 132 has a capacity capable of storing reproduction signal data corresponding to one track in this embodiment.

A description will now be given as to a processing procedure of reducing an interlayer cross talk component in the third embodiment with reference to FIG. 8.

Reproduction is first performed from a first track in N tracks in the vicinity of a target track of an optical disk 101 (a step S301). A reproduction signal from the first track obtained at a step S301 is converted into digital data by the ADC 131, and then written and temporarily stored in the memory 132 (the step S302). Subsequently, a track number i is set to 2 (a step S303), and reproduction from a second track is carried out (a step S304). A reproduction signal from the second track obtained at the step S304 is converted into digital data by the ADC 131, and then added to the reproduction signal data from the first track stored in the memory 132 to be averaged by the calculation unit 133 (a step S305). Averaged data (an intermediate calculation result of averaged data of reproduction signal data from the N tracks) obtained at the step S305 is overwritten in the memory 132 (a step S306). That is, the reproduction signal data from the first track which has been already stored in the memory 132 is substituted by the averaged data which is the intermediate calculation result.

Then, the track number i is increased by one (a step S308) until i=N is determined at a step S307, processing at the steps S304 to S306 is repeated, and averaged data as an intermediate calculation result is sequentially overwritten in the memory 132. As a result, a final calculation result by the calculation unit 133 is obtained when the Nth track is reproduced, and this result is finally stored in the memory 132 as compensation signal data. Thus, at the time of reproduction from the target track, the compensation signal data stored in the memory 132 is read, and the subtracter 134 performs a difference calculation between reproduction signal data from the target track output from the ADC 131 and the compensation signal data, thereby obtaining digital data of the reproduction signal in which an interlayer cross talk component is removed or reduced. When output data from the subtracter 134 is decoded by a decoder 135, reproduction information 136 which is not affected by the interlayer cross talk is obtained.

According to the third embodiment, the interlayer cross talk component is effectively reduced based on the same principle as that in the second embodiment. Moreover, according to the third embodiment, since overwriting is carried out in the memory 132 every time reproduction from one track in the N tracks is effected, the memory 132 may have a capacity corresponding to one track of the reproduction signal data. Therefore, the capacity of the memory 132 is reduced to 1/N as compared with the second embodiment.

In the second and third embodiments, the calculation in the calculation unit 135 is not limited to averaging, and it may be, e.g., addition. That is, the reproduction signal data from the N tracks is added to generate the compensation signal data. In this case, when performing the difference calculation between the reproduction signal data from the target track and the compensation signal data in the subtracter 134, a value of the reproduction signal data from the target track is multiplied by N, so that the same compensation signal data as that obtained when performing averaging can be obtained.

It is to be noted that the present invention is not limited to the foregoing embodiments as it is, and constituent elements can be modified and embodied without departing from the scope of the invention on an embodying stage. Additionally, various inventions can be formed by appropriately combining constituent elements disclosed in the foregoing embodiments. For example, some constituent elements can be eliminated from all constituent elements disclosed in the embodiments. Further, constituent elements in the different embodiments can be appropriately combined with each other.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An optical disk apparatus which reproduces information stored along tracks in recording layers of an optical disk, comprising:
a light illuminating medium which illuminates a light beam to a target track and at least one specific track of the optical disk;
a reproduction unit which detects a reflected light beam from the optical disk to generate a first reproduction signal from the target track and a second reproduction signal from the specific track;
a memory which stores a compensation signal obtained on the basis of the second reproduction signal and corresponding to a cross talk component between the recording layers;
a subtracter which subtracts the compensation signal from the first reproduction signal to generate a third reproduction signal; and
a decoder which decodes the third reproduction signal to obtain the information.

2. The optical disk apparatus according to claim 1, wherein the specific track is a track in a region of the optical disk where the information is not recorded, and the target track is a track in a region of the optical disk where the information is recorded.

3. The optical disk apparatus according to claim 2, wherein the specific track corresponds to one circuit of the tracks of the optical disk.

4. The optical disk apparatus according to claim 2, wherein the compensation signal is the second reproduction signal generated by the reproduction unit.

5. The optical disk apparatus according to claim 2, wherein phases of the cross talk components from the respective recording layers are uniformed.

6. The optical disk apparatus according to claim 5, wherein the reproduction unit samples and generates the first reproduction signal from each of the recording layers in a sampling cycle corresponding to the same rotation angle.

7. The optical disk apparatus according to claim 5, wherein the reproduction unit converts the first reproduction signal from each of the recording layers in such a manner that the number of sampling points for one track circuit becomes the same.

8. The optical disk apparatus according to claim 2, wherein the reproduction unit generates the second reproduction signals from the specific tracks, and the optical disk apparatus further comprises a calculation unit which generates the compensation signal based on the second reproduction signals.

9. The optical disk apparatus according to claim 8, wherein the memory stores the second reproduction signals, and the calculation unit performs calculation processing with respect to the second reproduction signals read from the memory to generate the compensation signal.

10. The optical disk apparatus according to claim 9, wherein the calculation processing by the calculation unit is addition averaging processing.

11. The optical disk apparatus according to claim 9, wherein the calculation processing by the calculation unit is addition processing, the compensation signal is hence a signal obtained by adding the second reproduction signals, and the subtracter subtracts the compensation signal from a signal obtained by multiplying the first reproduction signal by the number of the specific tracks.

12. The optical disk apparatus according to claim 8, wherein the calculation unit performs calculation processing with respect to the second reproduction signal and data stored in the memory every time the second reproduction signal is generated by the reproduction unit, and the memory overwrites and stores a calculation result obtained by the calculation unit.

13. The optical disk apparatus according to claim 12, wherein a first signal of the second reproduction signals is stored in the memory, second and subsequent signals of the second reproduction signals are subjected to calculation processing with data stored in the memory by the calculation unit, and a result of the calculation is stored in the memory.

14. The optical disk apparatus according to claim 13, wherein the calculation processing by the calculation unit is addition averaging processing.

15. The optical disk apparatus according to claim 13, wherein the calculation processing by the calculation unit is addition processing, the compensation signal is hence a signal obtained by adding the second reproduction signals, and the subtracter subtracts the compensation signal from a signal obtained by multiplying the first reproduction signal by the number of the specific tracks.
